(19) United States
(12) Patent Application Publication
(10) Pub. No.: US 2007/0009123 A1
(43) Pub. Date: Jan. 11, 2007

(54) Remote control unit for a hearing aid

(76) Inventors: Stefan Aschoff, Bubenreuth (DE); Jorg Bindner, Weisendorf (DE); Torsten Niederdrank, Erlangen (DE); Roland Weidner, Eggolsheim (DE)

Correspondence Address: SCHIFF HARDIN, LLP;PATENT DEPARTMENT, 6600 SEARS TOWER, CHICAGO, IL, 60606-6473, US

(21) Appl. No.: 10/554,829

(22) PCT Filed: Apr. 29, 2004
(86) PCT No.: PCT/EP04/50639

§ 371 Date: Aug. 23, 2006

(30) Foreign Application Priority Data
Apr. 30, 2003 (DE) 103195890

(51) Int. Cl. H04R 25/00

(52) U.S. Cl. 381/315

(57) ABSTRACT

A remote control device is provided for a hearing device, and which comprises an input interface which receives input information. A conversion device converts the input information into hearing device control commands. A transmission device transmits the hearing device control commands to the hearing device.

### BACKGROUND

The preferred embodiment concerns a remote control device for a hearing device, a mobile telephone, and a hearing device remote control system.

With many wearers of a hearing device there exists the desire to be able to adjust their hearing device to current situations in everyday use. In the hearing device industry, hearing devices are established that enable control elements on the housing, for example for the adjustment of the volume or for the selection of a program optimized for a specific environment situation. Naturally the dimensions of the control elements on the hearing device turn out to be very small. A fine motor dexterity is thereby demanded of the wearer of the hearing device, which is in particular not always provided in patients of advanced years. In addition to this, due to the position of the hearing device the control elements are located at an unusual position and can thus not be observed during the operation, which increases the possibility of a faulty operation.

### SUMMARY

It is an object to specify a technical teaching that enables a comfortable adaptation of a hearing device to a current situation and/or a current desire of the user.

A remote control device is provided for a hearing device, and which comprises an input interface which receives input information. A conversion device converts the input information into hearing device control commands. A transmission device transmits the hearing device control commands to the hearing device.

### BRIEF DESCRIPTION OF THE DRAWINGS

FIG. 1 is a block diagram of a hearing device remote control system.

### DESCRIPTION OF THE PREFERRED EMBODIMENTS

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

A remote control device of the preferred embodiment is equipped with an input interface for reception of input information.

This enables the remote control of a hearing device to occur with an input device that is already provided anyway for other purposes and that enables a particularly comfortable input of input information due to its size or its special and elaborate design. For example, via the remote control device hearing device settings can be changed, specific power characteristics of the hearing device can be freely applied or the hearing device can be switched into suitable operating modes.

A development of the preferred embodiment provides that the remote control device is equipped with a mechanical coupling device for detachable and re-attachable coupling to a mobile telephone (for cellular or wireless communication). This has the advantage that the remote control device can be offered as part of an accessory product for a mobile telephone or at least in part as an accessory product for a mobile telephone and functional units (such as, for example, the input device) of the mobile telephone that are already present anyway can thus also be used to control the hearing device.

The remote control device is preferably located at least in part (in particular wholly) within the housing of a mobile telephone. This has the advantage that the remote control device is integrated into the mobile telephone such that a very compact and easily manageable apparatus arises as a whole. In this context it is noted that this development of the preferred embodiment has many variations. For example, a conversion device of the remote control for conversion of the input information into hearing device control information can be wholly or partially realized in the mobile telephone. The conversion device can be wholly or partially realized by a processor device and/or circuit devices that are already present in the mobile telephone for control of the mobile telephone. Only the program-related setup for this processor these circuit devices is adapted to the remote control device and the corresponding applications. However, in addition or as an alternative to this, the conversion device can also be realized wholly or partially via a processor device or a circuit device that is realized in a separate housing outside of the mobile telephone housing. The case that only or additionally the input interface for the conversion device is located within the mobile telephone is also comprised within the preferred embodiment. The input interface can thereby be realized in a particular embodiment via the input interface that receives input information from the input device for control of the mobile telephone and forwards them to a processor device in any case.

All of these cited embodiments also have the advantage that elements (such as, for example, display, input device, power supply and/or processor or, respectively, circuit devices) provided and elaborately designed for a high-technology device are used repeatedly, here also for a remote control of a hearing device. This brings both cost and handling advantages.

According to an embodiment development, the hearing device control commands can comprise query commands that, in the hearing device, initiate the interrogation of hearing device information and the transfer of the hearing device information to the reception device. For example, the serial number of the hearing device, hearing device parameters or hearing device settings can be queried.

Another variation provides that the remote control device is equipped with a situation information interface for reception of situation information and with a conversion device for conversion of the situation information into hearing device control commands. The situation information can thereby be information that describe the current situation in which the hearing device, the hearing device user or the mobile telephone is directly found. This situation information can in particular be either determined by sensors or output by the mobile telephone specific components of the mobile telephone.

For example, the situation information can comprise information about whether a telephone connection is currently realized by the mobile telephone. A processor device (realized inside or outside of the mobile telephone, as a part of the remote control device or as a part of the mobile telephone) can be set up for this, such that a telephone connection control command is sent to the hearing device when a telephone connection is currently realized by the mobile telephone, whereby the hearing device is transferred into a telephone operating mode in which the hearing device settings are adapted to the situation “telephone connection”, in particular “mobile telephone connection”. This is advantageous since electrically-active components of the mobile telephone are brought into the proximity of the electrically-sensitive components of the hearing device by telephoning, which can lead to interferences that can at least be reduced via a suitable setting of the hearing device.

The situation information preferably comprises information about whether an incoming call is signaled to the mobile telephone. In the presence of this information, a call control command is sent to the hearing device. The output of a call signaling tone by the hearing device is caused by the call control command. This has the advantage that the hearing device user is reliably informed about incoming calls without the signal tone having to be set to an intolerable volume for people located in the surroundings.

The preferred embodiment also comprises a mobile telephone with an input device for input of input information, with an output interface for output of input information, and with one of the remote control devices explained above.

In addition to this, the preferred embodiment comprises a hearing device remote control system with a mobile telephone and a hearing device that is designed to receive and to process control commands that are sent by the remote control device.

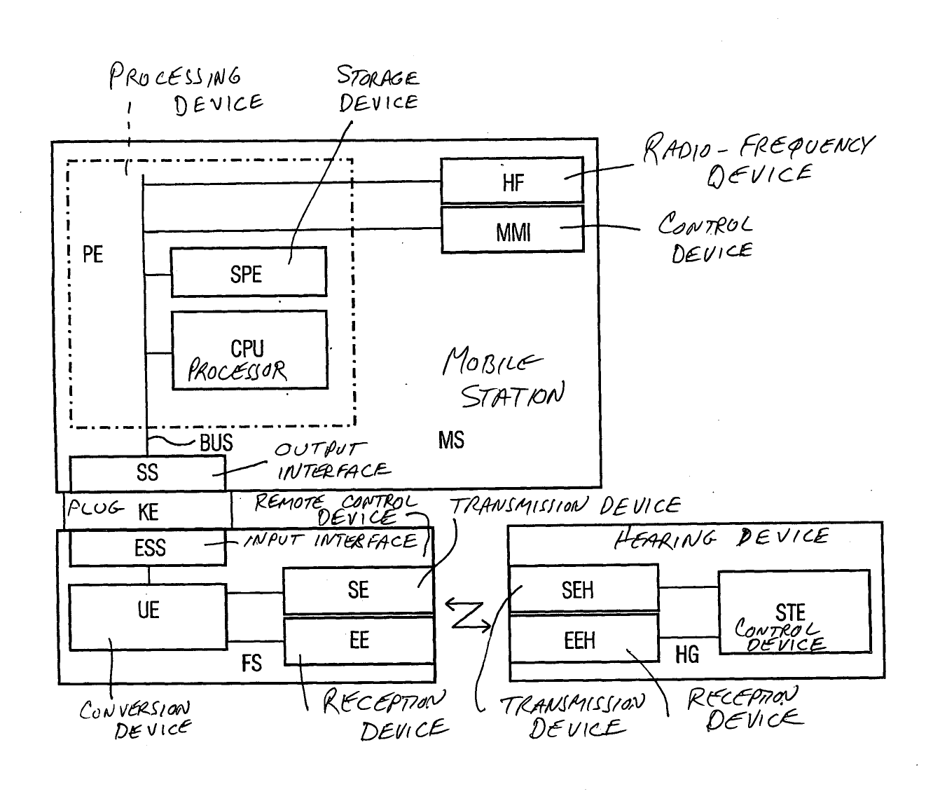

FIG. 1 shows a mobile station MS which comprises a control device MMI, a radio-frequency device HF and a processing device PE. The control device MMI comprises a display device such as, for example, a graphical display and actuation elements such as, for example, buttons or soft keys.

A program-controlled processor device PE (such as, for example, a microcontroller), that can also comprise a processor CPU and a storage device SPE, is provided for control of the mobile station MS and of the methods which are executed by the mobile station.

Depending on the embodiment variation, further components (associated with the processor device, belonging to the processor device, controlled by the processor device or controlling the processor device), for example a digital signal processor or further storage devices, can thereby be arranged inside or outside of the processor device PE, the principle function of which components is sufficiently known to an average man skilled in the art in connection with the processor device for controlling a mobile station and which is therefore not discussed in detail at this point. The different components can exchange data with the processor CPU over a bus system BUS or input/output interfaces and, if applicable, suitable controllers.

In particular the program data such as, for example, the control commands or control procedures that are drawn upon to control the mobile station are stored in the storage device SPE.

A communication between components of the mobile station and components of the remote control device FS that in particular serves for the transmission of input information is realized via an output interface SS of the mobile station MS and an input interface ESS of the remote control device corresponding with this.

The remote control device is additionally physically (in particular mechanically) connected with the mobile station via a plug KE.

The input information which are input by the user via the keyboard MMI of the mobile station and are transferred to the conversion device via the output or input interface are converted into hearing device control commands by a conversion device UE that can be realized via a circuit device provided solely for this purpose or via a processor device setup for this purpose. These hearing device control commands are then transmitted to the hearing device HG by means of a suitable transmission device SE (in particular a (Bluetooth) radio transmission device) and are received there by a corresponding reception device EEH (in particular a (Bluetooth) radio reception device) and are interpreted and converted by a hearing device control device STE that can likewise by realized by a processor device correspondingly set up in terms of programming. As an alternative to this the reception device of the hearing device can also be designed as a passive transponder that enables a reprogramming of the hearing device without further power consumption in the hearing device.

The hearing device HG additionally possesses a transmission device SHE, in particular a (Bluetooth) radio transmission device, for transmission of information to the remote control device FS which are received thereby in a corresponding reception device EE, in particular a (Bluetooth) radio reception device.

According to an embodiment variation, the hearing device control commands comprise a query command that triggers the interrogation of hearing device information in the hearing device and the transfer of this back to the remote control device and, if applicable, to the mobile station or even to the mobile radio system.

The following variations that comprise the interrogation of hearing device information are thereby considered as preferred embodiments:
the remote interrogation of the serial number of the hearing device;
the remote interrogation of results of an automatic self-test of the hearing device;
the remote interrogation of the current parameters of the hearing device that are influencing the acoustic properties, such as, for example, the amplification settings for all available amplification channels;
a ‘remote fitting’, i.e. an adjustment or fine adjustment of the hearing device implemented by a remotely-acting technician;
a selective activation of specific hearing device properties by a remotely-acting customer center that, if applicable, effects an activation after payment by the customer.

A further embodiment provides that the remote control device is provided via a situation information interface which, for example, is provided as part of or parallel to the output input interface, and is connected with the mobile station for transfer of situation information from the mobile station to the remote control device.

For example, such situation information can describe situations in which the user of the mobile station or the mobile station resides. The remote control device is thus signaled by means of the situation information when a connection will be is established by the mobile telephone, or when an incoming call is signaled to the mobile station. This situation information is then likewise converted by the conversion device UE into hearing device control commands which are interpreted and executed by the control device STE of high-frequency after transmission to the hearing device (see above). Situation information which signal that a connection will be is established by the mobile station leads to the circumstance that the hearing device is transferred into a telephone operation mode in which the hearing device is less susceptible to interference for the electromagnetic radiation specific for mobile stations. As an alternative or supplement to this, the directional microphone characteristic of the hearing device is deactivated during the telephone connection.

According to another embodiment variation, the environment noise is examined in the mobile station or in the remote control device and the current acoustic situation is classified constructed on this, i.e. a conclusion is made about which standard situation (of which a limited number is defined) is most similar to the current situation. This classification then initiates a data exchange that effects an adjustment in the hearing device of the acoustically-relevant parameters to a state that is optimized for this situation. This offers a large advantage as soon as a hearing device user sets a hearing device on both sides since a classification that is definite for both sides is ensured.

Situation information which signals that an incoming call is signaled to the mobile station leads to the circumstance that the hearing device outputs a call signal tone.

In addition to the embodiment variations explained above, a plurality of further embodiment variations which are not described here but which can be implemented simply in practice using the explained exemplary embodiments.

It is thus clear that, in alternative embodiment variations that are not shown in the Figure, the conversion device and therewith also the output input interface and/or the situation information interface can be wholly or partially realized within the housing of the mobile station and in particular via components already present anyway in the mobile station. For example, the conversion examination volume can be wholly or partially also realized by the processor device of the mobile station and the output input station and/or the situation information interface can be realized by process input output and/or corresponding data bus systems. The preferred embodiment also comprises the case that input information are supplied by the control device of the processor device to the mobile station and are converted there into hearing device control commands. The preferred embodiment also comprises the case that the processor device outputs control commands as soon as the corresponding situation information is internally detected. The power supply unit of the mobile station can also be drawn on for power supply of the remote control device. While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1-10. (canceled)

11. A remote control device for a hearing device, comprising:
an input interface which receives input information;
a conversion device which converts the input information into hearing device control commands; and
a transmission device which transmits the hearing device control commands to the hearing device.

12. A remote control device according to claim 11 including a mechanical coupling device for detachable and re-attachable coupling to a mobile telephone.

13. A remote control device according to claim 11 which is at least partially located within a housing of a mobile telephone.

14. A remote control device according to claim 11 with a reception device for reception of hearing device information, and wherein the hearing device control commands comprise query commands that initiate interrogation of the hearing device and transfer of the hearing device information to the reception device.

15. A remote control device according to claim 12 with a situation information interface for reception of situation information, and a conversion device for conversion of the situation information into the hearing device control commands.

16. A remote control device according to claim 15 in which the situation information comprises information about whether a telephone connection is currently realized by the mobile telephone, said conversion device being set up such that a telephone connection control command is sent to the hearing device when a telephone connection is currently realized by the mobile telephone, the hearing device being transferred into a telephone operating mode by the control command.

17. A remote control device according to claim 15 in which the situation information comprises information about whether an incoming call is signaled to the mobile telephone, said conversion device being set up such that a call control command is sent to the hearing device when an incoming call is signaled to the mobile telephone, output of a call signal tone by the hearing device being initiated by the call control command.

18. A remote control device according to claim 11 in which the input information arises from input of a user on an input device of a mobile telephone.

19. A mobile telephone, comprising:
an input device which inputs input information;
an output interface which outputs the input information; and
a remote control device for a hearing device comprising:
an input interface which receives said input information output from said output interface,
a conversion device which converts the input information into said hearing device control commands, and
a transmission device which transmits the hearing device control commands to the hearing device.

20. A hearing device remote control system, comprising:
a mobile telephone having an input device which inputs input information and an output interface which outputs the input information;
a remote control device;
a hearing device designed to receive and process hearing device control commands sent by the remote control device; and
said remote control device comprising:
an input interface which receives input information from said mobile telephone output interface,
a conversion device which converts the input information into said hearing device control commands, and
a transmission device which transmits the hearing device control commands to the hearing device.

21. A method for transmitting hearing device control commands to a hearing device, comprising:
providing a remote control device which receives input information;
providing a conversion device which converts the input information into said hearing device control commands; and
with a transmission device, transmitting the hearing device control commands to the hearing device.

22. A method of claim 21, including:
providing a mobile telephone which receives input information and outputs said input information; and
with the mobile telephone, sending the input information to the remote control device.
